(19) United States
(12) Patent Application Publication
(10) Pub. No.: US 2007/0248722 A1
(43) Pub. Date: Oct. 25, 2007

(54) Lidding system

(75) Inventor: Paul Eaton Willett, Whiteside (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Moffat Pty Ltd, Mulgrave (AU)

(21) Appl. No.: 11/728,714

(22) Filed: Mar. 26, 2007

(30) Foreign Application Priority Data
Mar. 30, 2006 (AU) 2006901638

(51) Int. Cl. A47J 36/06; A23B 7/148

(52) U.S. Cl. 426/106

(57) ABSTRACT

A lidding system for use with loaf tins in the production of a breaded product including at least one lid, each lid having a cover portion for covering a loaf tin, the lid including four side portions for positioning adjacent the sides of the respective loaf tin.

### FIELD OF THE INVENTION

The present invention relates to a lidding system for the baking of items such as bread and in particular square sandwich loaves of bread.

### BACKGROUND OF THE INVENTION

The baking of loaves of bread is traditional carried out by placing dough pieces into a open topped bread tin. As the dough pieces prove and rise during the baking process, the dough rises above the height of the tin to produce a domed shaped top of the baked loaf of bread.

More recently, square sandwich loaves of bread have become popular due to their ability to conveniently fit into lunch boxes, toasters and sandwich makers. Square sandwich loaves are formed by placing a simple sheet steel panel, commonly known in the industry as a “drop in lid”, on top of the tin. As the dough piece proves and rises during the baking process, it flattens against the lid. To ensure that a consistent square top is achieved, the rising loaf ideally lifts the lid slightly off the bread tin as it bakes. When baking is complete, the lid is ideally 15 to 20 mm above the tin, resting on top of the loaves. Square sandwich loaves are typically produced by placing a sausage shape dough piece into a bread tin (or pan). These tins are strapped together in straps of 2, 3 or more tins and the planar “drop in lid” fits over all 2 or 3 tins to close the tins.

While this lid has been in universal use over the past 50 years or so, it is not without its disadvantages. Firstly, in the proving process, a standard process prior to baking, the dough pieces prove in the tin and rise to just beneath the lid. The height of the dough piece when placed in the oven is critical in producing a consistently high quality product. If the dough height is too low baking bread will not rise sufficiently to be squared off by the lid. If the dough height is too high, the baking bread will rise too high thereby lifting the lid of the tin too far, thus causing “blow out” of the loaf top. The “blow out” of the loaf top occurs when the top of the rising loaf spreads out laterally against the lid to from an unsightly ledge. The “blow out” may close the air space between adjacent strapped baking tins, causing insufficient heat flow between the sides of adjacent tins sharing the “drop in lid”. This causes the sides of the loaves to under bake and hence collapse. The collapsed loaf sides combined with the unsightly top ledge creates a distorted loaf, known as a “key-hole” which is difficult to slice and bag. As a consequence, these distorted loaves may be rejected as waste.

Secondary, the baking of the sides of the middle loaf or loaves in the strap can be difficult, especially in non-convection type ovens. To overcome this problem, slots have been placed in the lids, in the areas between the tins, to assist in the convective air flow up between the tins. Despite this, baking dough pieces are often longer than necessary to obtain a crust on the sides of the middles loaf or loaves. As a consequence, the baking quality is diminished by the uneven heat transfer within the oven. This problem is increased in “blow out” loaves where the distorted loaf further restricts convective air flow.

It is well known in the bakery industry that sandwich or “squares”, as they are commonly known, must be constantly monitored while in the proof stage to ensure that they do not over proof and expand too high in the tins. There is no means of correcting over-proof, as pushing the dough down simply deflates the proof, thus adversely affecting quality.

Therefore, there is a need to address problems of “blow out” and uneven baking profiles in the baking of loaves of bread. The present invention is directed to addressing at least some of the abovementioned problems.

### SUMMARY OF THE INVENTION

According to the present invention, there is provided a lidding system for baking loaves of bread in a tin including at least one lid, each lid having a cover portion and four side portions, the four side portions are disposed on the cover portion to form a substantially enclosed void, wherein the side portions fit into the interior of the tin.

Dough pieces baked under this lidding system rise all the way into the enclosed void and up against the lid. The dough piece first bakes onto the lid shape, creating a crust on the upper portion of the sides of the loaf of bread. The additional conductive heat transfer of the side portions to the upper portion of the sides of the loaf of bread ensures the faster formation of a crust, thus preventing “blow out” which occurs in this region when the conventional lidding system is used.

The lidding system preferably includes two or more lids, wherein the lids are connected together by a connecting bar disposed on the top portion. The connecting bar preferably covers a relatively small area between each of the lids, so as to maximise the air space between the lids. This results in good convectional air flow around the tins during the baking operation.

These advantageous features of the lidding system contribute to faster more even baking which is more robust to variations in dough preparation and proofing. This results in the increased production of a more consistent high quality product with lower wastage.

### BRIEF DESCRIPTION OF THE DRAWINGS

FIG. 1a is a top view of a conventional lidding system.

FIG. 1b is a side view of the conventional lidding system of FIG. 1a for use with the strapped baking tins.

FIG. 2a is a top view of one embodiment of the present invention.

FIG. 2b is a side view of the lidding system of FIG. 2a for use with the strapped baking tins.

### DETAILED DESCRIPTION OF THE EMBODIMENTS

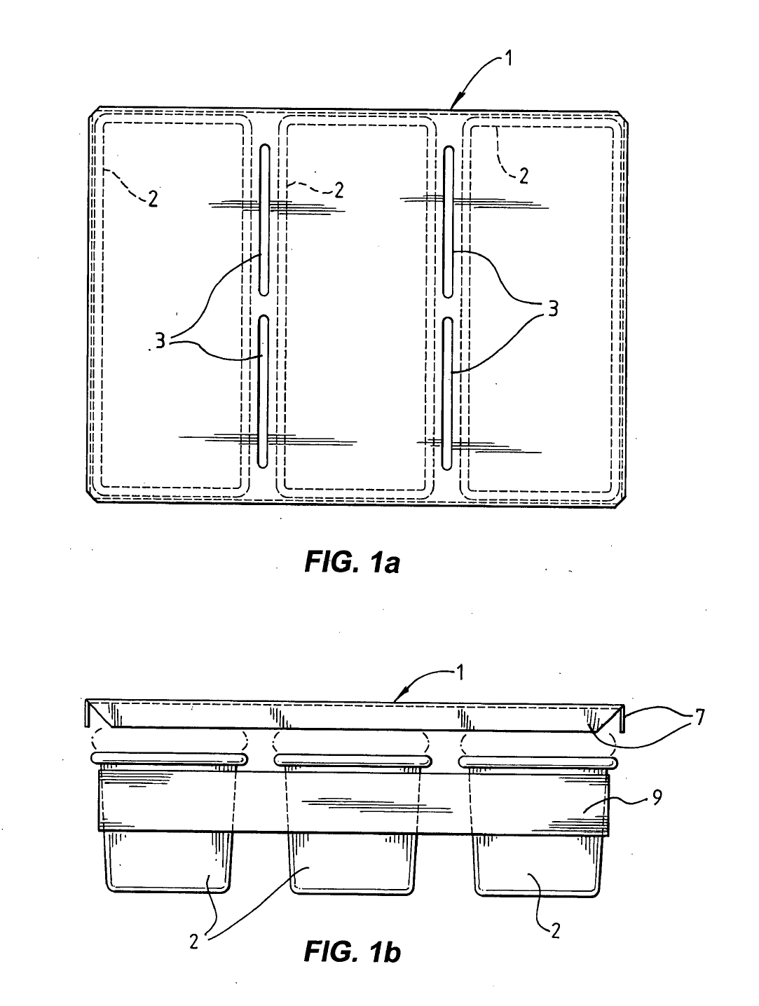

FIGS. 1(a) and 1(b) show an existing conventional lidding system for 3 rectangular loaf tins 2 held in position by strap 9 which is a metal (steel) band. The lidding system includes a lid 1 made from a sheet of plate steel material having spacings 3 formed therein and extending through the lid 1. The spacings 3 are positioned on the lid to correspond to the gap between the loaf tins 2 so that air can circulate and rise up between the tins. This is intended to provide even heating of all of the tins in the strapping 9.

The lid is provided with side 7 extending around the periphery of the lid 1. The sides of the lid are positioned to reside on the outside of the tins as shown. As can be seen from FIGS. 1(a) and 1(b), when the dough rises within the two, the sides 7 of the lid is not able to contact and thereby bake and form a crust on all sides of the top of each loaf.

Furthermore, the spacing 3 in the lid 1 of conventional lidding systems inhibits the flow of air. Further, the propensity of “blow out” of the baked item (typically bread) to occur may further restrict, and even totally block, air flow around the tins and between the lid spacing 3.

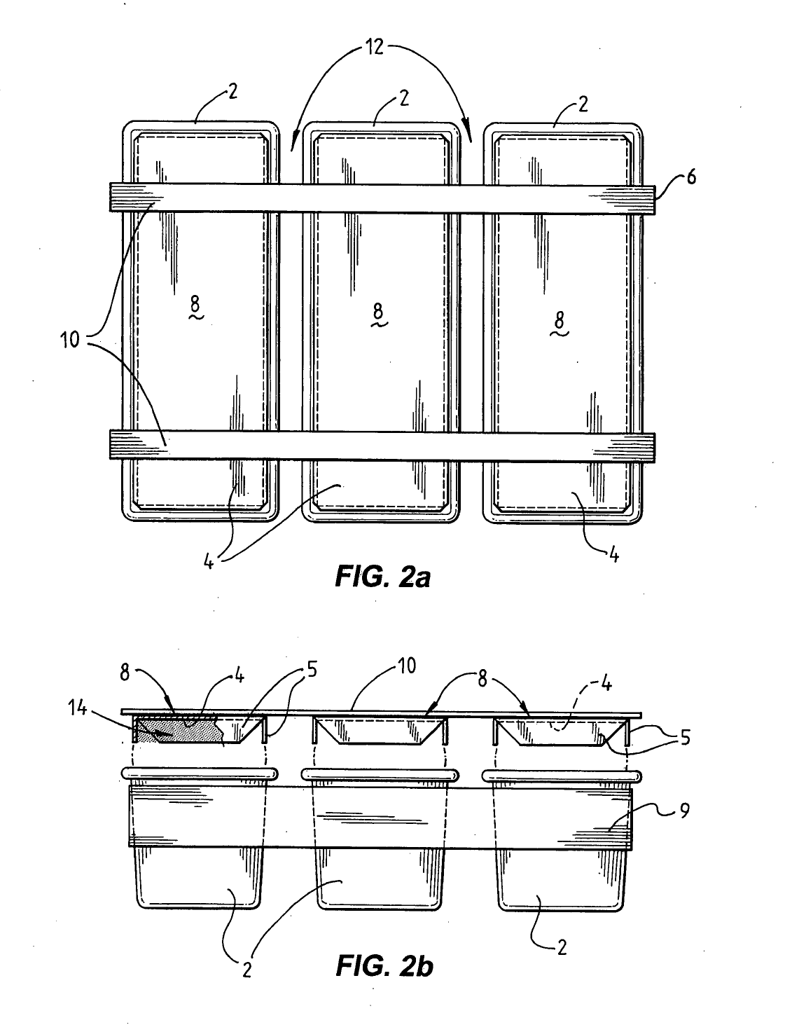

Referring to the FIGS. 2a and 2b, in a preferred embodiment of the present invention, the lidding system includes three lids 8, each having a top portion 4, and four side portions 5. The top portion and four side portions form a void underneath the lid which contains the rising dough. The lid is typically made of a semi-rigid sheet material, such as stainless steel or other suitable food grade heat stable material. As illustrated in FIG. 2b, the side portions taper at each end to eliminate hard to clean corners from the lids.

Preferably the lids 4 are connected together by a connecting portion 6 which may include two longitudinal rigid members 10 equally spaced along a central lateral axis. It will be appreciated that the connecting portion may alternatively consist of one longitudinal rigid member located on the central lateral axis. The width of the connecting portion is relatively narrow so that the connecting portion covers a relatively small area between each of the lids. This maximises the air space 12 between the lids and thus promotes convective air currents, and hence heat transfer, between and around the tins.

As mentioned above, with conventional lidding systems the baking of the sides of the middle loaf can be particularly difficult in non-convection type ovens, with the dough piece in the middle tins requiring longer to form a crust. In addition to increased spacing between the lids, the present invention enables quicker, more even cooking of the loaf sides particularly of the centre loaf or loaves though conductive heat transfer from the top portion 4 to the side portions 5.

The lids of the present invention are designed to enable the side portions to fit into the interior of each of the baking tins 2 and adjacent to the side walls of the baking tins. The baking tins are typically strapped together with a specified spacing between each tin. This is in contrast to conventional lidding systems (FIGS. 1a and 1b), where the side portions 7 are designed to slide over the exterior of the baking tins 2.

As mentioned above, with a conventional lidding system as shown in FIGS. 1(a) and 1(b) there is no means of correcting overproof, experienced bakers and rigorous control over the dough making and proofing stage is required to avoid excessive wastage due to poor quality product. The present invention provides a means to minimise the wastage through a lidding system which promotes a more robust baking process, which is more forgiving to variations in dough preparation and proofing. Thus, the present invention is particularly advantageous for use in operations employing trainee or inexperienced bakers.

In use, dough is placed into the baking tins 2 and placed into the oven. As the dough rises it fills the void 14 which is formed by the top and side portions of each lid. On the occasions when the dough is over-proof, the rising dough exerts vertical force on the lids, thus causing them to rise. The lids may rise up to about 50 mm, without excessive “blow out”. This is achieved due to the dough first baking to the lid shape, defined by the four side portions 5 and the top portion 4, creating a crust on the upper portions of the sides of the loaf. This is the region of the loaf which is prone to “blow-out”. Therefore by forming a crust in the top corner portion of the loaf, of similar width to the bottom corner portion of the loaf, the “blow-out” effect is minimised.

1. A lidding system for use with loaf tins in the production of a breaded product including at least one lid, each lid having a cover portion for covering a loaf tin, the lid including four side portions for positioning adjacent the sides of the respective loaf tin.

2. The lidding system of claim 1 including a plurality of lids connected together to cover a plurality of loaf tins, the lidding system being provided with venting regions between the lids corresponding to space between adjacent loaf tins.

3. The lidding system of claim 1 wherein the side portions fit adjacent the interior sides of the loaf tin.

4. The lidding system of claim 1 wherein the side portions fit adjacent the exterior sides of the loaf tin.

5. The lidding system of claim 1 wherein the plurality of lids are held together by a connection bar disposed on the cover portion of the lids.
